(19) United States
(12) Patent Application Publication
(10) Pub. No.: US 2006/0033089 A1
(43) Pub. Date: Feb. 16, 2006

(54) Lifting mechanism and spacer block arrangement for lifting jack

(75) Inventor: Chin-Hui Wang, Chia-I City (TW)

Correspondence Address: BACON & THOMAS, PLLC, 625 SLATERS LANE, FOURTH FLOOR, ALEXANDRIA, VA, 22314, US

(73) Assignee: SHINN FU CORPORATION, Lu Chu Hsiang (TW)

(21) Appl. No.: 10/914,145

(22) Filed: Aug. 10, 2004

(51) Int. Cl. B66F 3/24

(52) U.S. Cl. 254/93 H

(57) ABSTRACT

A lifting mechanism and spacer block arrangement is disclosed to include a magnetically attractive lifting mechanism installed in a lifting jack and driven to move a lifting rod vertically, and a plurality of magnetically attractive spacer blocks for attaching to the lifting mechanism at the bottom in a stack to space the lifting mechanism above the floor, each spacer block having a top side mounted with a magnet in a flush manner, and a bottom side fitting the top side for enabling the spacer blocks to be arranged in a stack and secured to the bottom side of the lifting mechanism.

### BACKGROUND OF THE INVENTION

(a) Field of the Invention

The present invention relates generally to a lifting jack and more particularly, to a lifting mechanism and spacer block arrangement for use in a hydraulic/air lifting jack.

(b) Description of the Prior Art

When wishing to lift a load, for example, a machinery, lathe, construction, etc., or to support a first member on a second member at the desired pitch, a small hydraulic/air lifting jack may be used. A small hydraulic/air lifting jack is highly movable, however it has a limited lifting stroke. When lifting a load, the user may have to operate the hydraulic/air lifting jack to lift the load to the desired elevation through several lifting stokes. Further, after each lifting stroke during a lifting operation, a respective movable support block is used to support the load in position and a spacer block is inserted under the lifting mechanism of the hydraulic/air lifting jack so that the lifting mechanism of the hydraulic/air lifting jack can be operated to lift the load again. If the spacer block in use cannot be positively maintained in position, the load and the lifting mechanism may fall, thereby resulting in an accident.

### SUMMARY OF THE INVENTION

The present invention has been accomplished under the circumstances in view. According to one aspect of the present invention, the lifting mechanism and spacer block arrangement comprises a lifting mechanism installed in a lifting jack and driven to move a lifting rod vertically, and a plurality of spacer blocks for attaching to the bottom side of said lifting mechanism to space said lifting mechanism above the floor or work place. According to another aspect of the present invention, the lifting mechanism and the spacer blocks are respectively made of a magnetically attractive material; each spacer block has a top side fitting the bottom side of the lifting mechanism, a magnet fixedly mounted in the top side in a flush manner, and a bottom side fitting the top side for enabling the spacer blocks to be arranged in a stack and secured to the bottom side of the lifting mechanism positively.

### BRIEF DESCRIPTION OF THE DRAWINGS

FIG. 1 is an exploded view of a lifting mechanism and spacer arrangement according to the present invention.

FIG. 2 is a sectional elevation of the lifting mechanism and spacer arrangement according to the present invention.

FIG. 3 is an elevational view of one spacer block according to the present invention.

FIG. 4 is a sectional view showing the use of the present invention (I).

FIG. 5 is a sectional view showing the use of the present invention (II).

FIG. 6 is a sectional view showing the use of the present invention (III).

FIG. 7 is a sectional view showing the use of the present invention (IV).

### DETAILED DESCRIPTION OF THE PREFERRED EMBODIMENTS

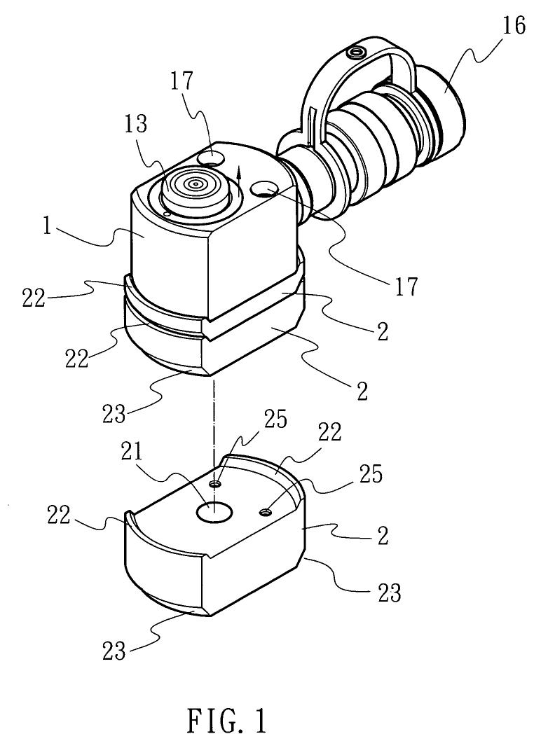

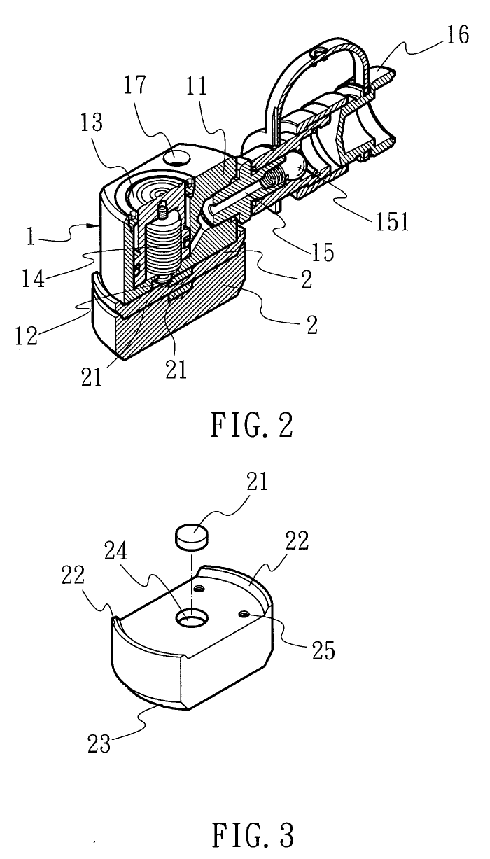

Referring to FIGS. 1 and 2, a lifting mechanism and spacer arrangement in accordance with the present invention is shown comprising a lifting mechanism 1 and a plurality of metal spacer blocks 2.

The lifting mechanism 1 comprises a magnetically attractive casing 11, which defines therein an oil chamber 12 and an oil inlet 15 in communication with the oil chamber 12, a lifting rod 13 mounted in the casing 11 and vertically movable in and out of the top side of the casing 11, a return spring 14 mounted inside the lifting rod 13 within the casing 11 and adapted to retract the lifting rod 13 after a lifting operation, an one-way valve 151 installed in the oil inlet 15, and a cover 16 for closing the oil inlet 15. When in use, the cover 16 is removed from the oil inlet 15, and then a hydraulic fluid is guided through the oil inlet 15 and the one-way valve 151 into the oil chamber 12 to lift the lifting rod 13 and the load at the lifting rod 13. After release of hydraulic fluid from the oil chamber 12, the return spring 14 immediately pulls the lifting rod 13 back to the inside of the casing 11. The lifting mechanism 1 can also be used in an air lifting jack so that compressed air can be supplied to the oil chamber 12 to lift the lifting rod 13.

Referring to FIG. 3, a spacer block 2 in accordance with the present invention is a magnetically attractive metal block member having a top hole 24 at the center of the top wall, a magnet 21 affixed to the top hole 24, two upright top flanges 22 at two sides of the top wall, and a chamfered bottom side 23.

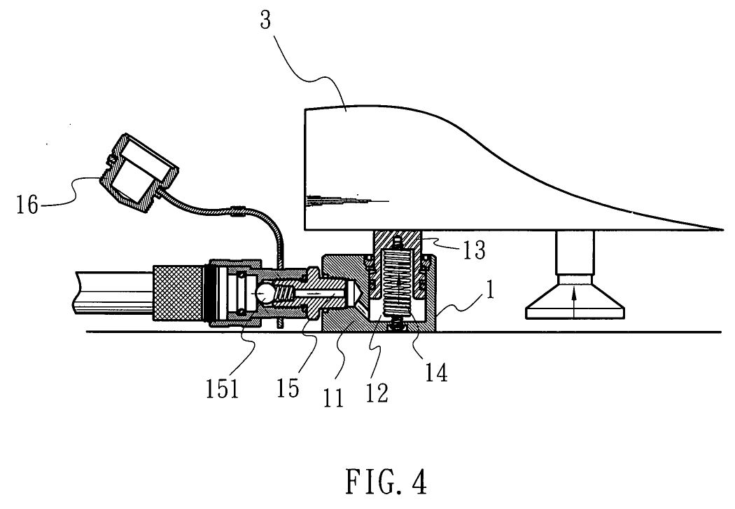

Referring to FIG. 4 and FIGS. 1-3 again, by means of inserting the chamfered bottom side 23 of one spacer block 2 into the space between the two upright top flanges 22 of another spacer block 2, a number of spacer blocks 2 are arranged in a stack and firmly secured together by means of magnetic attraction. Further, by means of the magnet 21, one spacer block 2 can positively be secured to the bottom side of the casing 11.

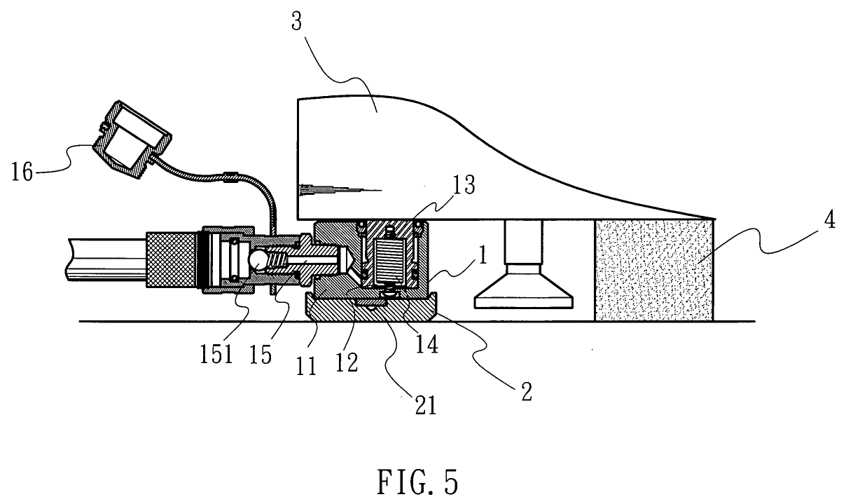

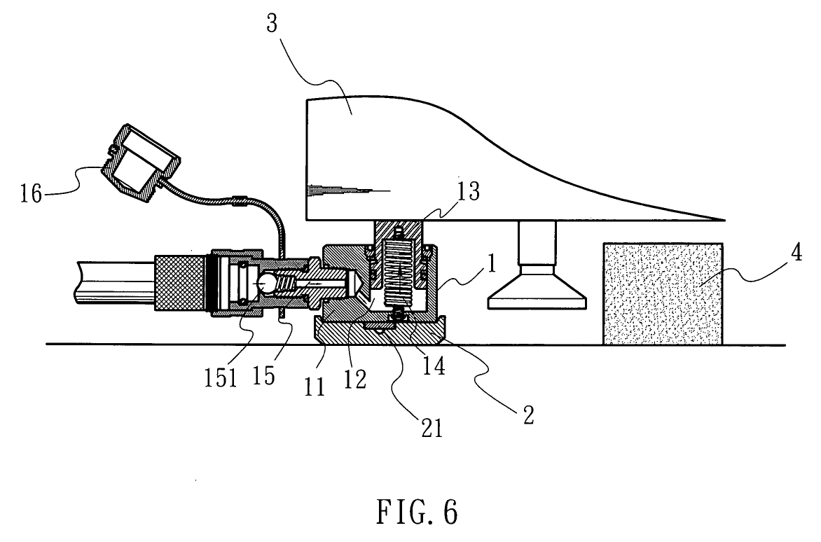

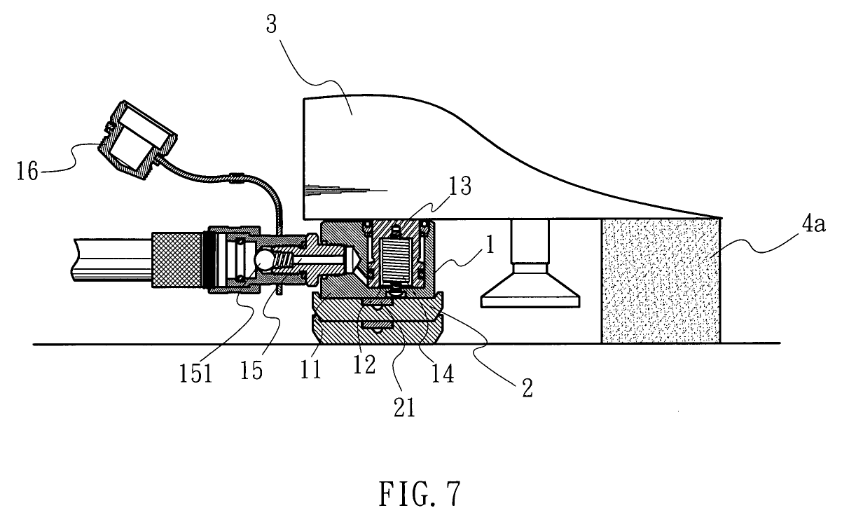

Referring to FIGS. 5-7, after one lifting stroke, a first movable support 4 is inserted under the load 3 to support the load 3 above the floor and then a first spacer block 2 is inserted into the gap between the casing 11 of the lifting mechanism 1 and the floor and secured to the bottom side of the casing 11 (see FIG. 5), and then the lifting jack is operated to move the lifting rod 13 to lift the load 3 for another lifting stroke (see FIG. 6), and then the first movable support 4 is taken away and a second movable support 4a is inserted under the load 3 to support the load 3 above the floor and then a second spacer block 2 is inserted into the gap between the first spacer block 2 at the bottom side of the casing 11 of the lifting mechanism 1 and the floor and secured to the bottom side of the first spacer block 2 (see FIG. 7). The aforesaid operation procedure is repeated until the load has been lifted to the desired elevation.

Referring to FIG. 1 again, the casing 11 has a plurality of mounting through holes 17 extended through the top and bottom walls. Each spacer block 2 has a plurality of mounting through holes 25 through the top and bottom walls. Through the mounting through holes 17,25, the casing 11 and the attached spacer block(s) 2 can be affixed to the floor or the equipment below by screws.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A lifting mechanism and spacer block arrangement comprising a lifting mechanism installed in a lifting jack and driven to move a lifting rod vertically, and a plurality of spacer blocks for attaching to a bottom side of said lifting mechanism to space said lifting mechanism above a supporting surface, wherein said lifting mechanism and said spacer blocks are respectively made of a magnetically attractive material; said spacer blocks each have a top side fitting the bottom side of said lifting mechanism, at least one magnet element fixedly mounted in the top side thereof in a flush manner, and a bottom side fitting the top side thereof for enabling said spacer blocks to be arranged in a stack and secured to the bottom side of said lifting mechanism.

2. The lifting mechanism and spacer block arrangement as claimed in claim 1, wherein said spacer blocks each have at least one upright flange upwardly extended from the border of the respective top side; the bottom side of each said spacer block is smoothly chamfered.

3. The lifting mechanism and spacer block arrangement as claimed in claim 1, wherein each said spacer block has at least one mounting hole in the top side thereof for holding the respective at least one magnetic element.

4. The lifting mechanism and spacer block arrangement as claimed in claim 1, wherein said lifting mechanism has a plurality of mounting through holes; each said spacer block comprises a plurality of mounting through holes respectively connectable to the mounting through holes of said lifting mechanism by a respective screw bolt.
